(19) United States
(12) Patent Application Publication
(10) Pub. No.: US 2008/0066399 A1
(43) Pub. Date: Mar. 20, 2008

(54) FLEXIBLE COMPOSITE HURRICANE PROTECTION APPARATUS AND SYSTEM

(75) Inventors: Omer Akdag, Stuart, FL (US); Michael Francis Ciferri, Port St. Lucie, FL (US)

Correspondence Address: POWELL GOLDSTEIN LLP, 901 NEW YORK AVENUE, N.W., 3RD FLOOR, WASHINGTON, DC, 20001-4413, US

(73) Assignee: DONOVAN ENTERPRISES, INC., Stuart, FL (US)

(21) Appl. No.: 11/533,563

(22) Filed: Sep. 20, 2006

(51) Int. Cl. E06B 3/26

(52) U.S. Cl. 52/202

(57) ABSTRACT

A flexible hurricane shutter is provided. A composite laminate material is constructed using layers of high elastic modulus fibers or fiber bundles. The material also can be coated with a membrane on one or both sides to improve the elastic strength and wind- and water-resistance of the material to provide further protection. The fibers or fiber bundles also can be encased in a coating to prevent the fiber or fiber bundles from fraying, to prevent corrosion on metallic fibers, or to provide additional strength or flexibility to the material. The flexible hurricane shutter can be adapted to be secured directly to an exterior feature of a structure to cover an opening in the structure such as a window. Alternatively, the flexible hurricane shutter can be adapted to be secured to an extrusion extending from the exterior of a structure, either directly or by means of a keder and keder track.

### FIELD OF ART

Aspects of the invention described herein relate to a flexible composite material for use in protecting structures from damage from flying projectiles during a storm such as a hurricane or tornado or from some other source such as an explosion or blast. Aspects of the invention can also provide protection from wind and rain damage as well as protection from projectile damage and thus provide substantial protection to a structure.

### BACKGROUND

Tropical storms and hurricanes are the costliest natural disasters in terms of loss of property and life. Much of the wind-related damage occurs when missile-like airborne debris hits a structure and penetrates a glass window or other opening such as a door, garage door, or sky light, allowing wind and wind-driven rain to intrude into the structure. People living in hurricane-prone areas thus understand the importance of covering such fragile openings of a building prior to the hurricane and that doing so greatly reduces the risk of property damage. In addition, in the wake of recent intense hurricane seasons, most property insurance companies are giving discounts for premiums for the properties with proper hurricane protection. Thus, there is an incentive for people to protect their structures from possible hurricane damage.

In the past, hurricane protection was accomplished by covering the windows, doors, etc. of the structure by using one or more sheets of plywood or by using commercially available hurricane protection devices, often known as hurricane shutters. Commercially available hurricane shutters are required to meet certain standards such as those introduced by local building codes or national standards such as those promulgated by the American Society for Testing and Materials (ASTM). Typical hurricane shutter testing consists of impact testing followed by pressure testing (static and cyclic) to determine how the material holds up to an impact such as from flying debris and pressure such as from high wind gusts and high sustained winds. Impact testing is conducted by firing small and large objects having predetermined dimensions and weight on a hurricane shutter at specified impact speed out of air cannon. A typical test would utilize, for example, a 2″×4″ wooden board weighing approximately 9 lbs. or a small ball-shaped object fired at a speed of 50 ft/sec or higher. The projectile is directed at different portions of the hurricane shutter to determine how such different portions react. After the impact testing is conducted, pressure testing is conducted by applying static and cyclic pressure into the hurricane shutter to simulate gusting and sustained winds and to determine how well the shutter protects even after being impacted by flying debris.

The common commercially available hurricane shutters are designed to have rigid structures and are usually fabricated from steel, high-strength aluminum or impact-resistant polymers in order to comply with the aforementioned standards and reduce their deflection under load. However, these shutters often block or attenuate the sun light and alter the exterior appearance of buildings, and therefore often are installed or utilized only just before the hurricane and are removed afterwards.

In addition to the rigid hurricane shutter, in recent years flexible hurricane shutters were introduced to the market. These flexible hurricane shutters are typically fabricated from commercially available high-strength woven fabrics. Although flexibility and light weight give them great advantage for handling, installation and storage, their excessive deformation under impact and/or pressure load is far greater than for a rigid hurricane shutter, and thus makes them unsuitable for use in many situations since they will not provide sufficient protection to the underlying structure. Several prior art patents describe ways in which a solution to the excessive deflection problem on the flexible hurricane shutters has been sought. For example, U.S. Pat. No. 6,325,085 to Gower describes the excessive deflection of the flexible hurricane shutter and sought to overcome the problems of commercially available textile materials by installing the flexible hurricane shutter with an angle on an opening on the structure. Similarly, U.S. Pat. No. 6,176,050 to Gower describes mounting the flexible hurricane shutter at a sufficient distance from the structure to accommodate the deflection of the flexible material used and anchoring the shutter to permit it to absorb the loads without being torn from its support. Both of these prior art patents utilize commercially available fabrics and do not address the material used in the hurricane shutter itself.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter.

Aspects of the embodiments described herein relate to the need for an apparatus and system for protecting structures such as homes or commercial buildings or other objects such as automobiles or the like from damage caused by flying debris for example, during a hurricane, tornado, or other storm, and further to protect from damage due to rain, hail, or wind. A flexible hurricane shutter is provided that utilizes two or more layers of fibers or fiber bundles formed in a matrix to provide protection from, for example, debris impact and wind pressure. The matrix can further be coated with a membrane to provide additional protection from wind, rain, and small debris particles. Exemplary ways of mounting the flexible hurricane shutter are shown.

### BRIEF DESCRIPTION OF THE DRAWINGS

FIG. 1 depicts an exemplary installation of a rigid hurricane shutter known in the art.

FIGS. 2A-2D depict examples of commercially available rigid hurricane shutters known in the art.

FIGS. 3A and 3B depict ways in which commercially available rigid hurricane shutters can be attached to an exterior wall of a structure.

FIG. 4 depicts the dynamics of a prior art flexible hurricane shutter during impact.

FIG. 5 depicts an installation of flexible hurricane shutter known in the art.

FIG. 6 depicts a weave pattern of a fabric used in a flexible hurricane shutter known in the art.

FIG. 7 depicts a matrix form of fibers and surrounding membrane according to one or more aspects described herein.

FIGS. 8A and 8B depict a fiber and a fiber bundle according to one or more aspects described herein.

FIGS. 9A and 9B depict attachment of a surrounding membrane to a fiber matrix according to one or more aspects described herein.

FIGS. 10A-10C depict mounting arrangements for a flexible hurricane shutter according to one or more aspects described herein.

FIGS. 11A-11C depict further aspects of mounting arrangements for a flexible hurricane shutter according to one or more aspects described herein.

### DETAILED DESCRIPTION

The various aspects summarized previously can be embodied in various forms.

The following description shows by way of illustration of various combinations and configurations in which the aspects can be practiced. It is understood that the described aspects and/or embodiments are merely examples, and that other aspects and/or embodiments can be utilized, and structural and functional modifications can be made, without departing from the scope of the present disclosure. In particular, it should be noted that although the aspects herein are described in the context of a flexible shutter for use to protect a structure from damage, they also can be used to protect other objects that can be exposed to damage such as automobiles, gardens, or outdoor furniture. Further, although the flexible composite material according to aspects herein is described in the context of providing protection from damage caused during a hurricane or other storm such as a tornado, it can also be used to protect against damage from other causes such as an explosion or blast.

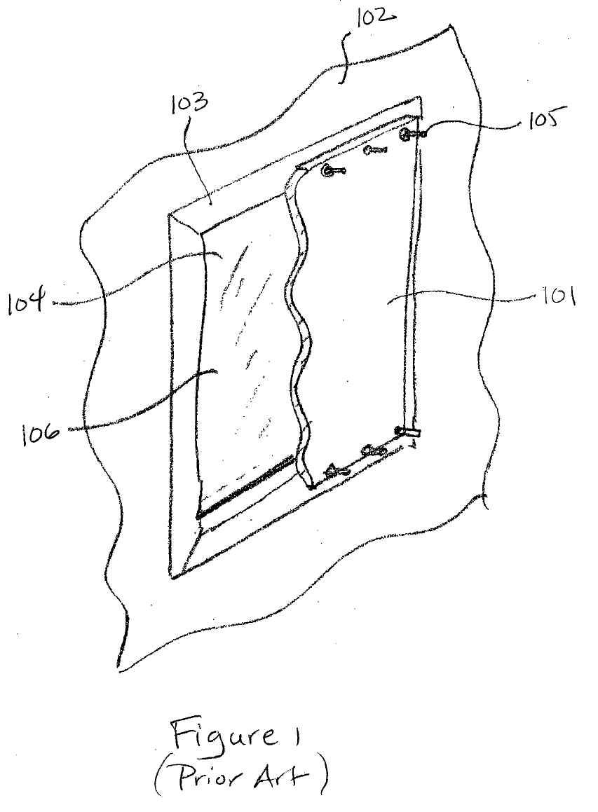

FIGS. 1-6 illustrate aspects of hurricane shutter applications known in the art.

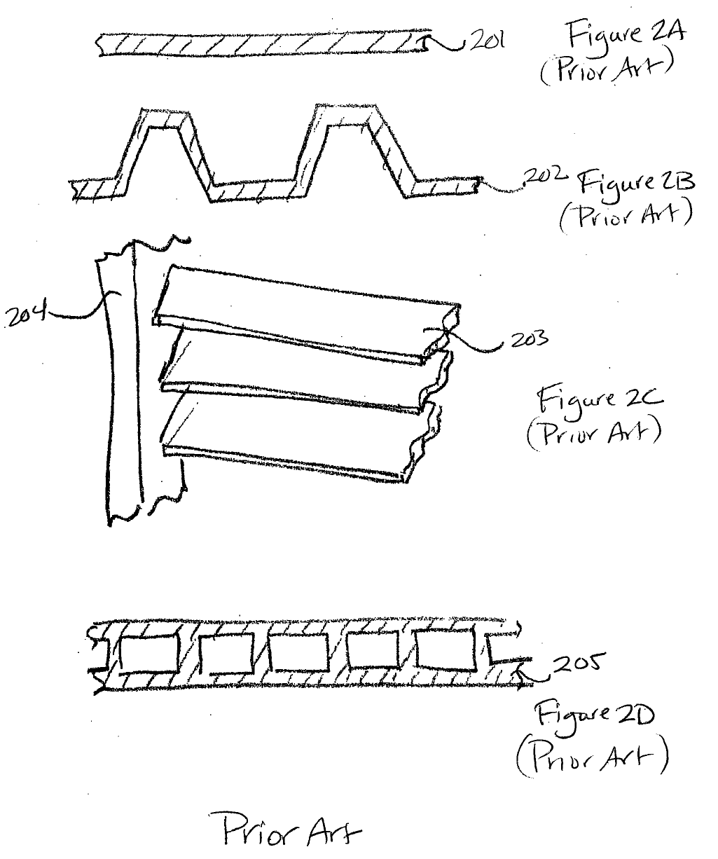

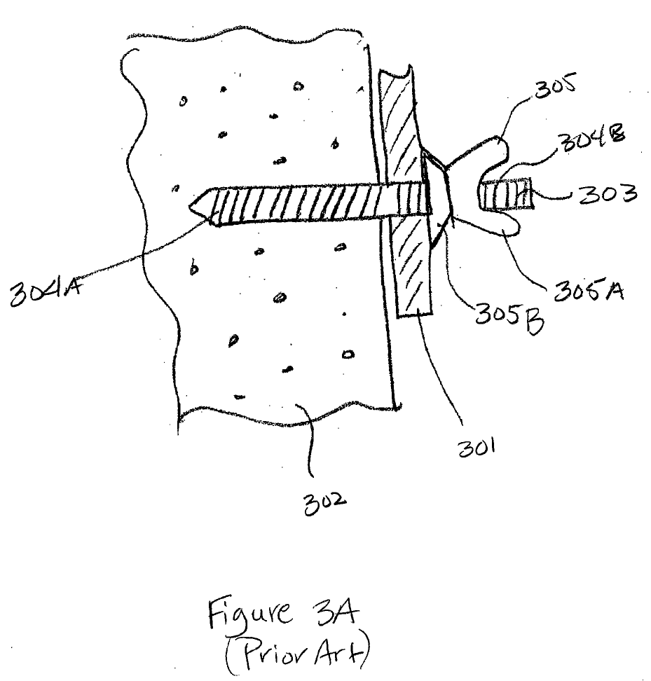

FIG. 1 illustrates a typical rigid hurricane shutter application known in the art. As shown in FIG. 1, hurricane shutter 101 is placed over an opening 104 in an exterior wall of a building 102 by placing the shutter 101 over a frame 103 surrounding opening 104 and securing it to the frame 103 using installation hardware 105. Typically, opening 104 is covered by a glass window 106, since it is that type of opening that is most in need of protection. FIGS. 2A-2D show cross-sections of some commercially available rigid hurricane shutters. FIG. 2A shows a flat shutter 201, which is usually made of plywood having a thickness of ⅝″ or more. FIG. 2B shows a corrugated hurricane shutter 202, which combines rigidity with low weight and is usually fabricated from steel, aluminum or high-strength plastics. FIG. 2C shows a typical configuration commonly known as Bahamas shutters, which are composed of vertical flat strips 203 attached to a rigid frame 204 at an angle so as to deflect debris and protect from impact damage; in some embodiments of Bahamas shutters, the strips 203 operate on a pivot so that the user can change their angle relative to the frame 204 to provide additional protection or to let in light or air. FIG. 2D shows a typical “sandwich pattern” used in some commercially available hurricane shutters, most commonly used in shutters made of high-impact polymer, with the shape compensating for the low elastic modulus of the plastic material.

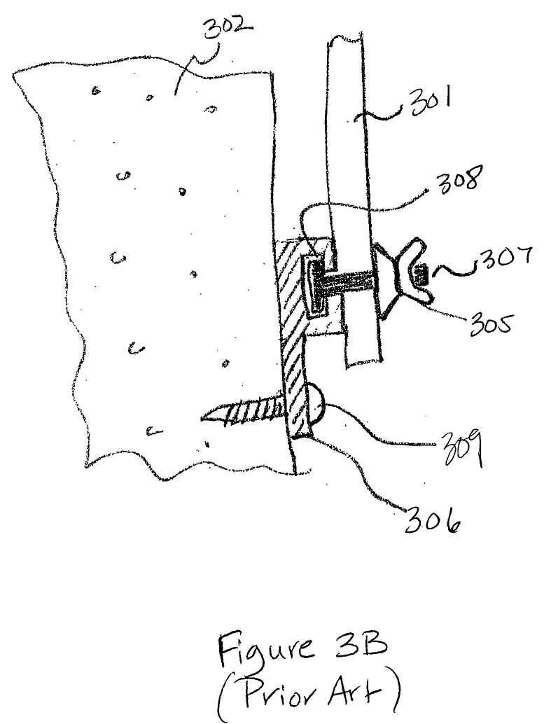

FIGS. 3A and 3B depict exemplary ways in which a rigid hurricane shutter in the prior art is attached to the exterior of a structure. As shown in FIG. 3A, hurricane shutter 301 can be attached to an exterior wall 301 of a building by means of a combination of a screw 303 and nut 305 having wings 305A, with the shutter 301 being sandwiched between wall 301 and nut 305. The type of screw 303 used can vary depending on the material making up the exterior wall. For example, screw 303 can have a first section 304A for penetrating into the wall, which has threads suitable for masonry, wood, or steel, depending on the application, and have a second section 304B which remains outside the wall and can be a simple machine thread. In addition, wing nut 305 often will have a large flat surface 305C that abuts the shutter so as to spread out the load and aid in installation. FIG. 3B shows an alternative mounting configuration, with shutter 301 being mounted to wall 302 using a special track 306 designed for use with T bolts 307 and wing nut 305. In such a case, the track 306 often is permanently affixed to the exterior wall by masonry or wood screws 309. In this configuration, T bolt 307 can slide along a groove 308 in track 306, and the spacing of the T bolts 307 can be adjusted during installation as necessary.

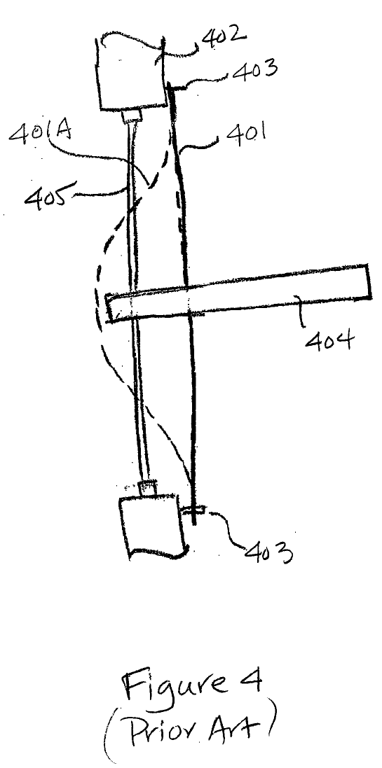

As is known in the prior art, a flexible hurricane shutter also can be installed on the opening of a structure in a similar manner. FIG. 4 shows the dynamics of a flexible hurricane shutter 401 during a high-speed impact from debris 404. In FIG. 4, shutter 401 is attached to exterior wall 402 by means of mounting hardware 403 to cover window 405. As is shown in FIG. 4, when flexible shutter 401 experiences a high-speed impact from debris 404, it deflects from its original position to position 401A, allowing debris 404 to impact window 405 and cause window 405 to break, thus causing additional wind and rain damage as described above.

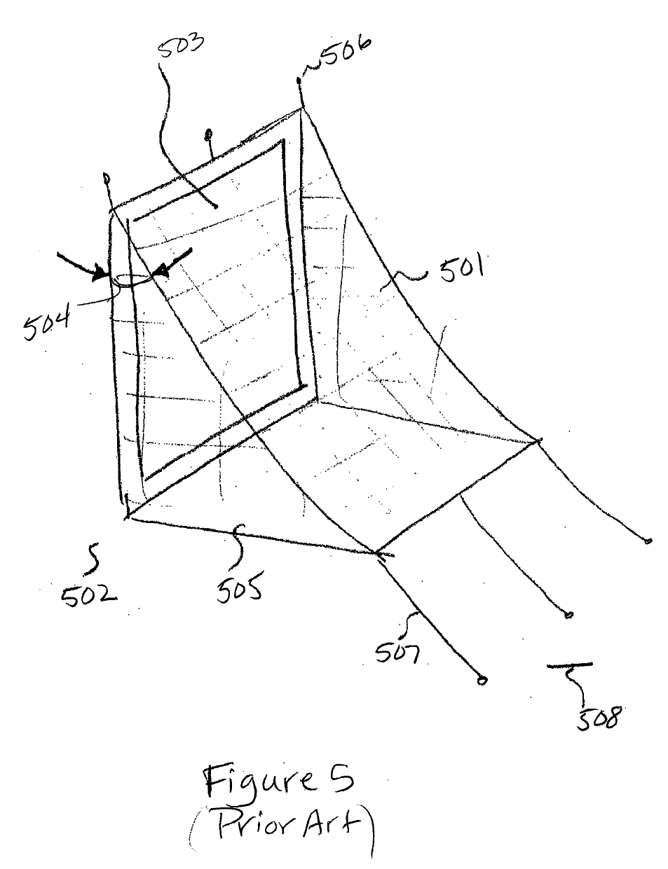

FIG. 5 illustrates one way in which the problem of excessive deflection of a flexible hurricane shutter has been addressed in the prior art. As shown in FIG. 5, a flexible hurricane shutter 501 having side curtains 505 is mounted over window 503 in structure 502 at an angle 504. The angle 504 keeps the flexible hurricane shutter 501 at a greater distance from window 503 than a simple flat installation as shown in FIG. 4. The shutter 501 is secured to the structure 502 by means of mounting hardware 506 and is further secured to the ground 508 by means of installation straps 507.

As is known in the art, several factors can contribute to the deformation of a flexible hurricane shutter. First, the size of the shutter is a factor, with a larger shutter having greater surface area typically experiencing greater deflection than a smaller shutter with less surface area. Second, the magnitude of the load on the shutter can affect deformation, with a greater impact (due to a combination of the size of the object striking the shutter and its speed) and/or greater pressure causing more deformation than a lesser impact or pressure. Third, the density of the weave used in the fabric can affect deformation. Fourth, the waviness of the woven fibers, as shown in FIG. 6, can affect the stability of the fabric and thus its resistance to deformation. Fifth, the density of the fibers in the woven fabric also is a factor in determining the extent of deformation. As shown in FIG. 6, the less dense the weave 601 of the fabric, the more light and air that is permitted to penetrate; however, such a fabric is more prone to deformation under impact or pressure. Finally, the extent of deformation can be affected by the modulus of elasticity (also known in the art as “Young's modulus” or simply “modulus ”) of the fibers used to construct the shutter, either in the fabric or in other materials such as installation straps 507 shown in FIG. 5. For example, polyester, which typically has a modulus of elasticity of 500,000 PSI, will deform more than steel, which generally has a modulus of elasticity of 30,000,000 PSI. However, fibers with higher modulus of elasticity tend to be stiffer then the fibers with lower modulus of elasticity, and thus might not have the desired degree of flexibility.

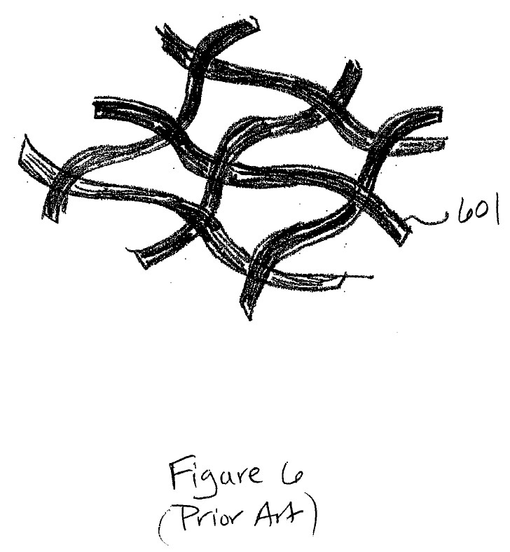

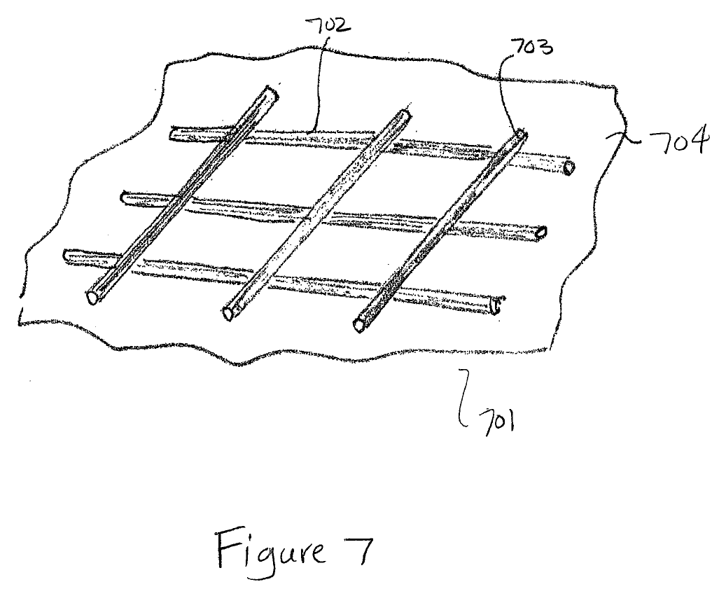

FIG. 7 shows a flexible hurricane shutter according to one or more aspects described herein. As shown in FIG. 7, a flexible hurricane shutter 701 can comprise one or more layers of fibers 702 and 703 arranged in a matrix and coated with a membrane 704. Fibers 702 and 703 can be made of materials having a relatively high modulus of elasticity, such as, for example, steel, aluminum, carbon or glass fiber, KEVLAR ballistic fiber manufactured by DuPont, or polymers such as polyester, vinyl, propylene, any other metallic, non-metallic, organic or inorganic, or polymer fibers. Fibers 702 and 703 can be arranged in a matrix pattern wherein fiber 703 crosses fiber 702 at some angle between the two. For simplicity, fibers 702 and 703 are depicted as being “horizontal” and “vertical,” respectively, but it should be noted that the angle between fibers 702 and 703 can be anywhere between about 1 and 90 degrees, i.e., fibers 703 and 703 can be anywhere from nearly parallel to perpendicular to each other. In addition, although the term “fiber” is used to describe elements 702 and 703 shown in FIG. 7, such elements can also comprise fiber bundles made up of one or more types of individual fibers, arrangements wherein one of elements 702 and 703 comprises a single fiber while the other comprises a fiber bundle, or arrangements where one of elements 702 and 703 comprises a fiber bundle made up of one combination of fibers while the other comprises a different fiber bundle. In addition, membrane 704 can provide further protection and act to block smaller debris particles or wind-driven water such as rain or storm surge. Membrane 704 can be made of any number of materials such as vinyl, nylon, polyethylene, polyester, propylene, etc. any other metallic, non metallic, organic or inorganic, or polymer membrane materials. It should be emphasized that the materials listed above for use in fibers 702 and 703 and for membrane 704 are given by way of example only and are not in any way intended to be limiting, and other materials can also be used in a flexible hurricane shutter according to on or more aspects described herein.

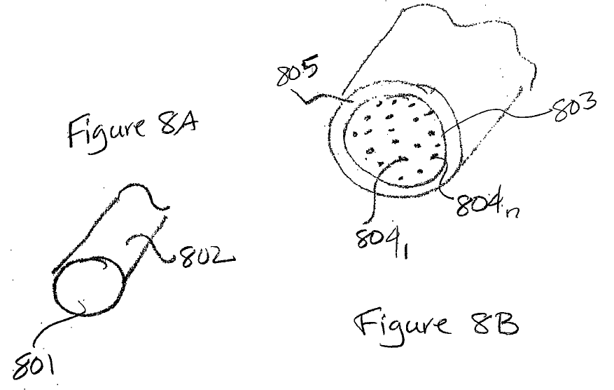

FIGS. 8A and 8B show cross-sections of individual fibers and fiber bundles according to one or more aspects described herein. FIG. 8A shows an individual fiber 801. FIG. 8B shows a fiber bundle 803 made up of individual fibers 804₁ . . . 804ₙ. According to one or more aspects, the fiber 801 or fiber bundle 803 can be encapsulated in a coating 802 or 805 before being placed in a matrix with other fibers. Coating 802 or 805 can serve several purposes, for example, to prevent fiber 801 or fiber bundle 803 from fraying, to prevent corrosion on metallic fibers, or to provide additional strength or flexibility to the material. In addition, according to one or more aspects, coating 802/805 can also be used as an additional bonding agent in attaching an outer membrane to the fiber matrix, for example, if a heat or adhesive method is used to attach the outer membrane. As with the composition of the fibers as described above, coating 802 or 805 can be made of materials having thermo-plastics or thermo-set plastics such as vinyl, polyester, nylon, epoxy, phenolic, and other organic or inorganic materials.

FIGS. 9A and 9B show ways in which a membrane can be attached to a fiber matrix to form a flexible hurricane shutter according to one or more aspects described herein. As shown in FIG. 9A, a membrane 901 can be attached on one side of a matrix formed by fibers 902A and 902B or as shown in FIG. 9B, membrane 903A and 903B can be attached on both sides of a matrix formed by fibers 904A and 904B. Membrane 902 or 903A/903B can be attached to the matrix in many different ways, and the method of attachment can depend on the composition of fibers used in the matrix. For example, membrane 902 or 903A/903B can be attached to the matrix by stitching, heat, thermal fusion, adhesives, or any other available methods known in the art.

According to one or more aspects described above, the composition of the fibers, coating, and membrane and thus of the hurricane shutter can be tailored to meet a wide range of different needs and different uses, and can be configured so that the shutter is strong enough to handle a wide range of impact and pressure loading applied by hurricane-force winds and wind-borne debris.

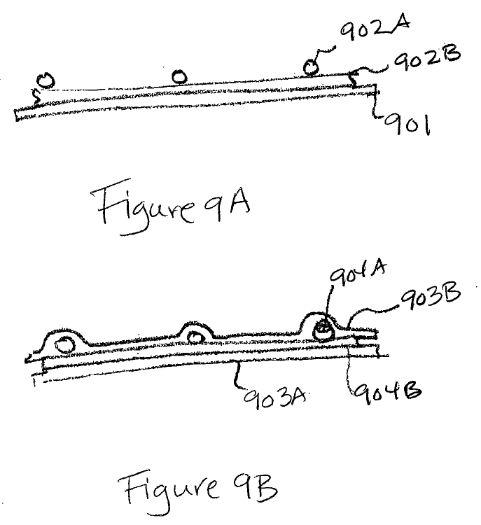

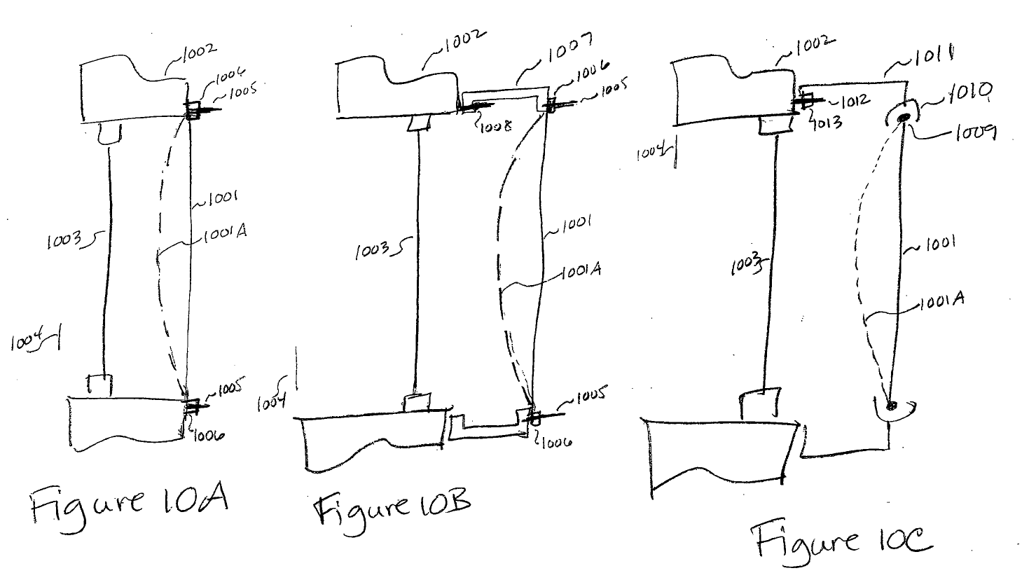

FIGS. 10A-10C show ways in which a hurricane shutter according to one or more aspects described herein can be mounted to a structure.

FIG. 10A shows an exemplary way in which a hurricane shutter can be mounted to a structure 1004 if the distance between an exterior surface of the building and a window 1003 is greater than a predicted maximum deflection 1001A. As shown in FIG. 10A, a flexible hurricane shutter 1001 having a maximum predicted deflection shape of 1001A can be mounted on structure 1004 having a frame 1002 around an opening in the structure such as window 1003. The shutter 1001 can be secured to frame 1002 by means of screw 1005 and nut 1006 and can be attached and removed as needed.

FIG. 10B shows an exemplary way in which a hurricane shutter can be mounted to a structure 1004 if the distance between an exterior surface of the building and a window 1003 is less than a predicted maximum deflection 1001A. As shown in FIG. 10B, a flexible hurricane shutter 1001 having a maximum predicted deflection shape of 1001A can be mounted on structure 1004 having a frame 1002 around an opening in the structure such as window 1003 by securing an extrusion 1007 to frame 1002 by means of screw 1008 and securing shutter 1001 to frame 1002 by means of screw 1005 and nut 1006. Extrusion 1007 can be made of a variety of materials such as plastic, aluminum, steel, or the like, depending on the application and the desired combination of strength and flexibility. Both shutter 1001 and extrusion 1007 and can be attached and removed as needed.

FIG. 10C shows an alternative way in which a hurricane shutter can be mounted to a structure 1004 if the distance between an exterior surface of the building and a window 1003 is less than a predicted maximum deflection 1001A. As shown in FIG. 10C, shutter 1001 can be mounted on structure 1004 having a frame 1002 around an opening in the structure such as window 1003 by securing one end of an extrusion 1007 to frame 1002 by means of screw 1008 as in FIG. 10B. In FIG. 10C, instead of being secured to extrusion 1007 by means of a screw and nut assembly as in FIG. 10B, hurricane shutter 1001 can be configured with a keder 1009 such as is known in the art maintained within a keder track 1010 on an end of the extrusion opposite the end secured to the structure.

In FIG. 10C, the other end of the extrusion has a channel 1010 configured to accept a keder 1009 known in the art and securing shutter 1001 to frame 1002 by means of screw 1005 and nut 1006. Extrusion 1007 can be made of a variety of materials such as plastic, aluminum, steel, or the like, depending on the application and the desired combination of strength and flexibility. Both shutter 1001 and extrusion 1007 and can be attached and removed as needed.

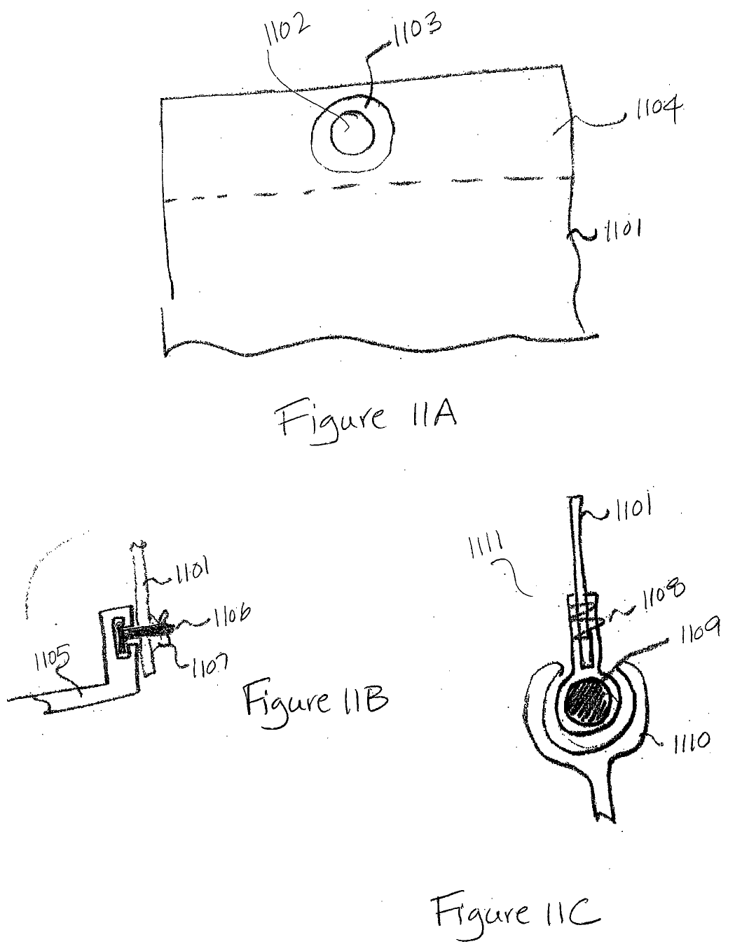

FIGS. 11A-11C further illustrate ways in which a flexible hurricane shutter in accordance with various aspects herein can be configured for attachment to a structure. As shown in FIG. 11A, one way in which a flexible hurricane shutter 1101 can be configured for attachment is by way of a grommet hole 1102 reinforced by grommet 1103 on an edge 1104 of the flexible hurricane shutter 1101. To reduce the risk of tearing or other damage to shutter 1101, edge 1104 can be strengthened by, for example, doubling the material of the flexible hurricane shutter by folding it onto itself, by adding additional webbing onto the edges by stitching or bonding with heat weld or adhesives, or any other means of reinforcing flexible materials known in the art.

FIG. 11B shows a detailed view of a way in which a flexible hurricane shutter in accordance with aspects described herein can be attached to an extrusion as shown in FIG. 10B. As shown in FIG. 11B, flexible hurricane shutter 1101 can be attached to extrusion 1 105 by means of a T-bolt 1 106, for example, through a grommet hole 1102 reinforced by grommet 1103 as shown in FIG. 11A, and further secured by wing nut 1107.

FIG. 11C shows a detailed view of a keder and keder track, both known in the art, that can be used for securing a flexible hurricane shutter to an extrusion. As shown in FIG. 11C, keder 1111 comprises a cord 1109 having one end of the material 1108 comprising the flexible hurricane shutter folded around it and secured to the remainder of the flexible hurricane shutter 1101 by means of, for example, a stitched seam, hot weld, adhesive, or any other means of bonding a material to itself. Cord 1109 can be made of any number of different materials, such as rubber, nylon, or steel cable, depending on the application and the desired properties of the keder. Keder 1111 is maintained within keder track 1110 that forms an end of an extrusion opposite the end attached to the structure. Keder tracks or any other aforementioned extrusion can be installed either horizontally or vertically on any opening of a structure to be protected.

Although the present invention has been described in terms of preferred and exemplary embodiments thereof, numerous other embodiments, modifications and variations within the scope and spirit of the appended claims will occur to persons of ordinary skill in the art from a review of this disclosure.

What is claimed is:

1. A protective cover including:
a first layer of a plurality of first members arranged in a first pattern;
a second layer of a plurality of second members arranged in a second pattern, the second layer being disposed on the first layer to form a matrix comprising the first and second layers, the matrix having a first outer surface comprising an outer surface of the first layer and a second outer surface comprising an outer surface of the second layer; and
a membrane disposed on at least one of the first and second outer surfaces.

2. The protective cover of claim 1, wherein at least one of the first and second members comprises a metallic fiber.

3. The protective cover of claim 1, wherein at least one of the first and second members comprises a non-metallic fiber.

4. The protective cover of claim 1, wherein at least one of the first and second members comprises a polymer fiber.

5. The protective cover of claim 1, wherein at least one of the plurality of first and second members is encased in an outer coating.

6. The protective cover of claim 1, wherein the membrane comprises a polymer material.

7. The protective cover of claim 1, wherein the membrane is heat-sealed to the at least one first and second outer surface to form a laminate.

8. The protective cover of claim 1, wherein the membrane is stitched to the at least one first and second outer surface to form a laminate.

9. The protective cover of claim 1, wherein the membrane is mechanically attached to the at least one first and second outer surface to form a laminate.

10. A protective cover system, including:
a protective cover comprising:
a plurality of first members arranged in a first pattern;
a plurality of second members arranged in a second pattern, the second layer being disposed on the first layer to form a matrix comprising the first and second layers, the matrix having a first outer surface comprising an outer surface of the first layer and a second outer surface comprising an outer surface of the second layer; and
a membrane disposed on at least one of the first and second outer surfaces;
wherein the protective cover is adapted to be secured to an exterior feature of a structure.

11. The protective cover system of claim 10, wherein the protective cover is adapted to be secured directly to the exterior feature.

12. The protective cover system of claim 10, wherein the protective cover is adapted to be secured to an extrusion positioned between the protective cover and the exterior feature.

13. The protective cover system of claim 12, wherein the extrusion further comprises a track and the protective cover is adapted to be secured within the track.

14. The protective cover system of claim 13, wherein the track comprises a keder track and the protective cover further comprises a keder adapted to be secured within the keder track.

15. A protective cover composite material, the composite material comprising:
a first layer comprising a plurality of first members arranged in a first pattern;
a second layer comprising a plurality of second members arranged in a second pattern, wherein the second layer is disposed on the first layer to form a matrix comprising the first and second layers, the matrix having a first outer surface comprising an outer surface of the first layer and a second outer surface comprising an outer surface of the second layer; and
a membrane disposed on at least one of the first and second outer surfaces.

16. The composite material of claim 15, wherein the plurality of first members and the plurality of second members is the same.

17. The composite material of claim 15, wherein the plurality of first members and the plurality of second members is different.

18. The composite material of claim 15, wherein at least one of the first and second members comprises a metallic fiber.

19. The composite material of claim 15, wherein at least one of the first and second members comprises a non-metallic fiber.

20. The composite material of claim 15, wherein at least one of the first and second members comprises a polymer fiber.

21. The composite material of claim 15, wherein at least one of the plurality of first and second members comprises a single fiber.

22. The composite material of claim 15, wherein at least one of the plurality of first and second members comprises a fiber bundle, the fiber bundle comprising a plurality of fibers.

23. The composite material of claim 15, wherein at least one of the plurality of first and second members is encased in an outer coating.

24. The composite material of claim 15, wherein the membrane comprises a polymer material.

25. The composite material of claim 15, wherein the membrane is heat-sealed to the at least one first and second outer surface to form a laminate.
